(19) United States
(12) Patent Application Publication
(10) Pub. No.: US 2017/0278070 A1
(43) Pub. Date: Sep. 28, 2017

(54) CONTENT ACCESS BASED ON LOCATION OR TIME

(71) Applicant: AirWatch LLC, Atlanta, GA (US)

(72) Inventors: Alok Desai, Atlanta, GA (US); Gaurav Halbe, Atlanta, GA (US); Aditya Shrotri, Atlanta, GA (US); Pranay Swar, Atlanta, GA (US); Akshay Dhokale, Atlanta, GA (US)

(21) Appl. No.: 15/081,462

(22) Filed: Mar. 25, 2016

(51) Int. Cl. G06Q 10/10; H04W 4/02

(52) U.S. Cl. CPC G06Q 10/1095; H04W 4/023

(57) ABSTRACT

Disclosed are various approaches for providing access to content based on the location of a client device or the current time. A calendar service creates an event comprising a time and a duration. The calendar service assigns a beacon identifier to the event. The calendar service then links a document to the event. Finally, the calendar service sends an invitation to a client device, wherein the invitation corresponds to the event.

### BACKGROUND

Hard copies of documents are often distributed to attendees of meetings for security reasons. For example, members of a board of directors might be handed paper copies of documents containing confidential information that is not intended to leave the boardroom. In order to control access to the information in these instances, each copy of a paper document can be individually numbered (e.g., “1 of 25” or “14 of 15”). Before all attendees are allowed to leave, each document is collected and the documents are counted to confirm that all copies have returned before the attendees leaving the meeting.

Using hard copies of documents has a number of security benefits. Documents cannot be copied without the use of a photocopier, camera, or similar equipment. An attendee attempting to use photocopying equipment in a meeting to make unauthorized copies of a document is likely to be noticed. Likewise, destruction of paper documents is essentially permanent. Once burned or shredded in an appropriate manner, a hard copy of a document is impractical, if not impossible, to reassemble in order to recover the information contained in the document. Accordingly, access to physical documents can be limited to the location of a meeting (e.g., the meeting room) and for the duration of the meeting (e.g., requiring all copies to be returned before anyone leaves the meeting room) in a practical manner.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A is an example of a document viewer displaying a document in response to being in proximity to a beacon.

FIG. 1B is an example of a document viewer displaying an error message in response to being outside the broadcast range of a beacon.

FIG. 2 is an example of a beacon placed at a location to limit access to content.

FIG. 3 is a schematic block diagram of a network environment.

FIG. 4 is a user interface diagram depicting an invitation to an event according to various implementations.

FIG. 5 is a flowchart depicting the operation of various components.

FIG. 6 is a flowchart depicting the operation of various components.

FIG. 7 is a flowchart depicting the operation of various components.

### DETAILED DESCRIPTION

Disclosed are various examples for limiting access to digital content on a client device based on time or location using beacons. For example, a user can receive on his or her client device an invitation to attend an event. The invitation can specify a location for the meeting (e.g., a conference room), an identifier of a beacon associated with the location of the meeting, a time for the meeting, and a duration of the meeting. The invitation can also include a link to access documents or copies of documents. A document viewing application installed on the client device can then allow a user to access the documents while the meeting is in progress and the client device is within range of the identified beacon. Once the meeting ends or the client device moves out of range of the beacon, the document viewing application can cease to provide the user with access to the documents.

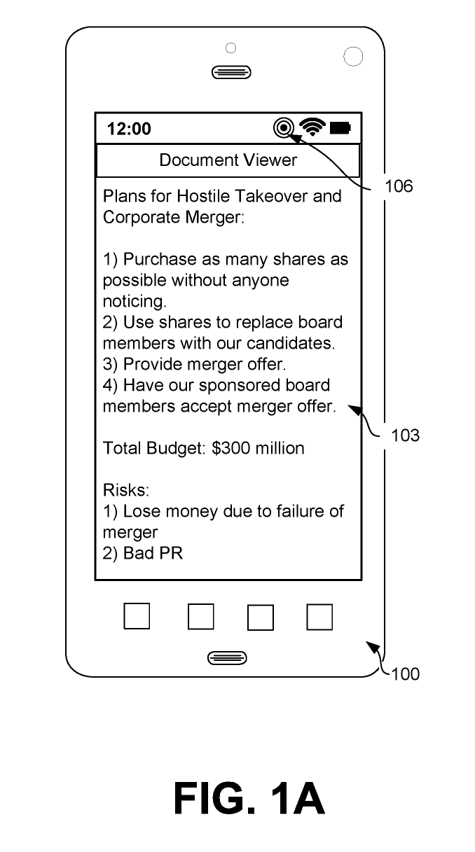

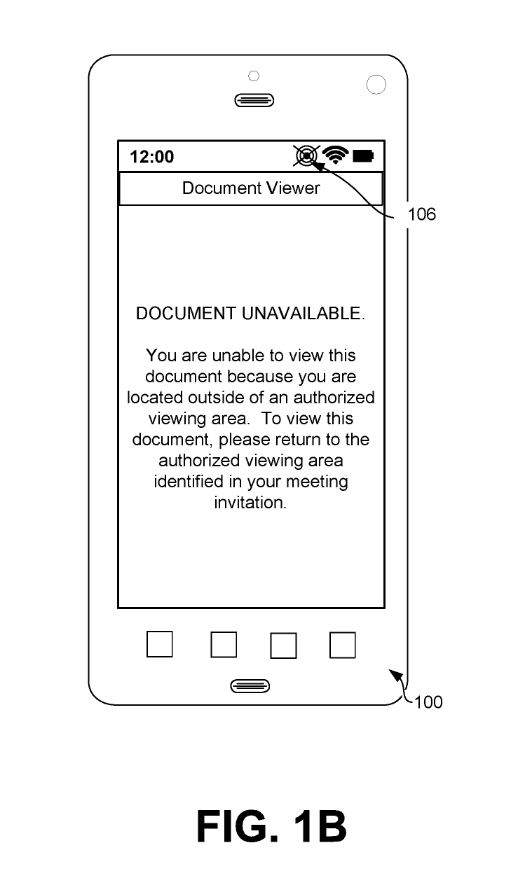

FIG. 1A is an example of the operation of the document viewing application in some examples. A client device 100 executes the document viewing application to display a document 103 while an event is in progress and the client device 100 is within range of a beacon. In some instances, the client device 100 can provide a beacon indicator 106 to show a user that the client device 100 is within range of a beacon.

FIG. 1B is another example of the operation of the document viewing application in some examples. Here, document viewing application executing on the client device 100 displays a message indicating that the document 103 is unavailable and providing a reason why the document 103 is no longer available to the user. For example, the document 103 can be unavailable because the event has ended. As another example, the document 103 can be unavailable because the client device 100 has moved out of range of the beacon. In some instances, the client device 100 can provide a beacon indicator 106 to show a user that the client device 100 has moved out of range of a beacon.

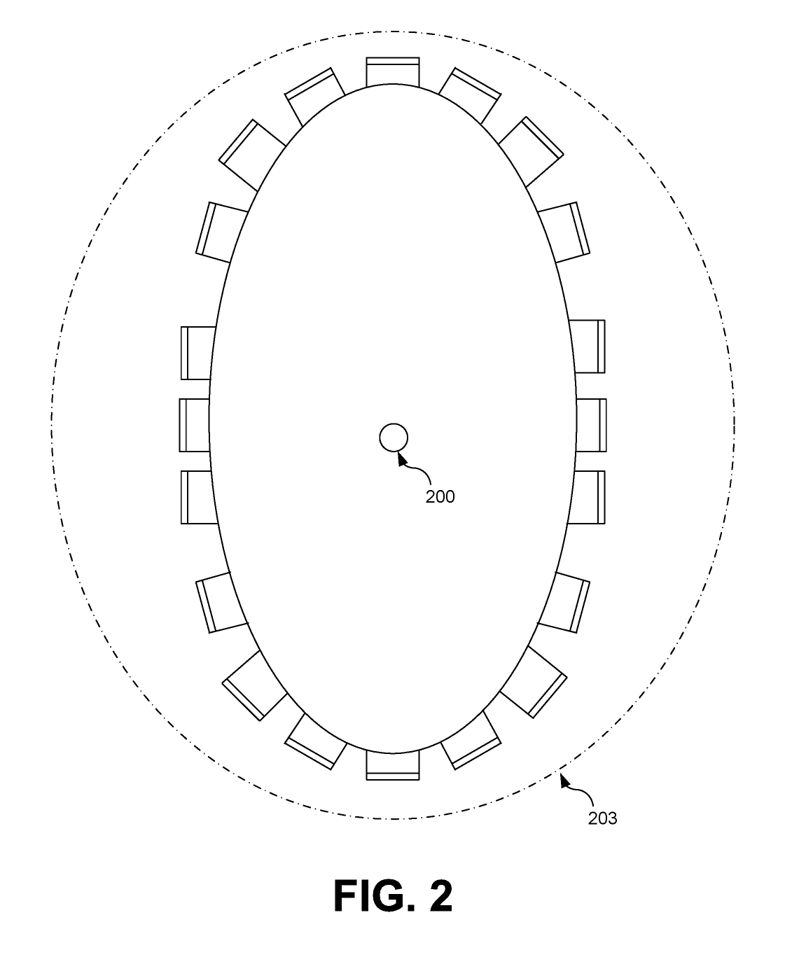

FIG. 2 is an example of how a beacon 200 can be deployed in order to limit access to a document 103. Here, a beacon 200 is placed in the middle of a conference table around which attendees of a meeting would sit. The beacon has a limited range, as indicated by the boundary 203. A client device 100 within the boundary 203 and configured to receive broadcasts from the beacon 200 can be provided with copies of documents 103 associated with the meeting. Likewise, a client device 100 outside the boundary 203 would be unable to receive broadcasts from the beacon 200 and therefore would be denied access of copies to the documents 103.

Further, if a client device 100 were to cross the boundary 203, then the ability of the client device 100 to access the documents 103 would change. For example, if a client device 100 were to move away from the conference table, then the ability of the client device 100 to access the documents 103 would be revoked. Likewise, if a client device 100 were to move towards the conference table, then the client device 100 can be provided with access to the documents 103 once the client device 100 crossed the boundary 203 and was within range of the beacon 200.

A beacon 200 can include any electronic device with a radio transmitter that broadcasts an identifier that uniquely identifies the beacon 200 relative to other beacons 200. For example, a beacon 200 using the APPLE® IBEACON® protocol can include a BLUETOOTH® transmitter that broadcasts a universally unique identifier (UUID) according to the BLUETOOTH Low Energy (LE) protocol. As another example, a beacon 200 using the GOOGLE® EDDYSTONE® protocol can broadcast a UUID using the BLUETOOTH LE® protocol. In other instances, a beacon 200 can correspond to a transmitter that broadcasts the media access control (MAC) address of the BLUETOOTH radio included in the beacon 200. A beacon 200 can similarly be implemented using other protocols. For example, a beacon 200 can broadcast using the WIGIG® protocol, as specified by the IEEE 802.11ad standard, operating at 60 gigahertz in order limit broadcasts to a particular room due to the inability of 60 gigahertz signals to pass through wall or other objects.

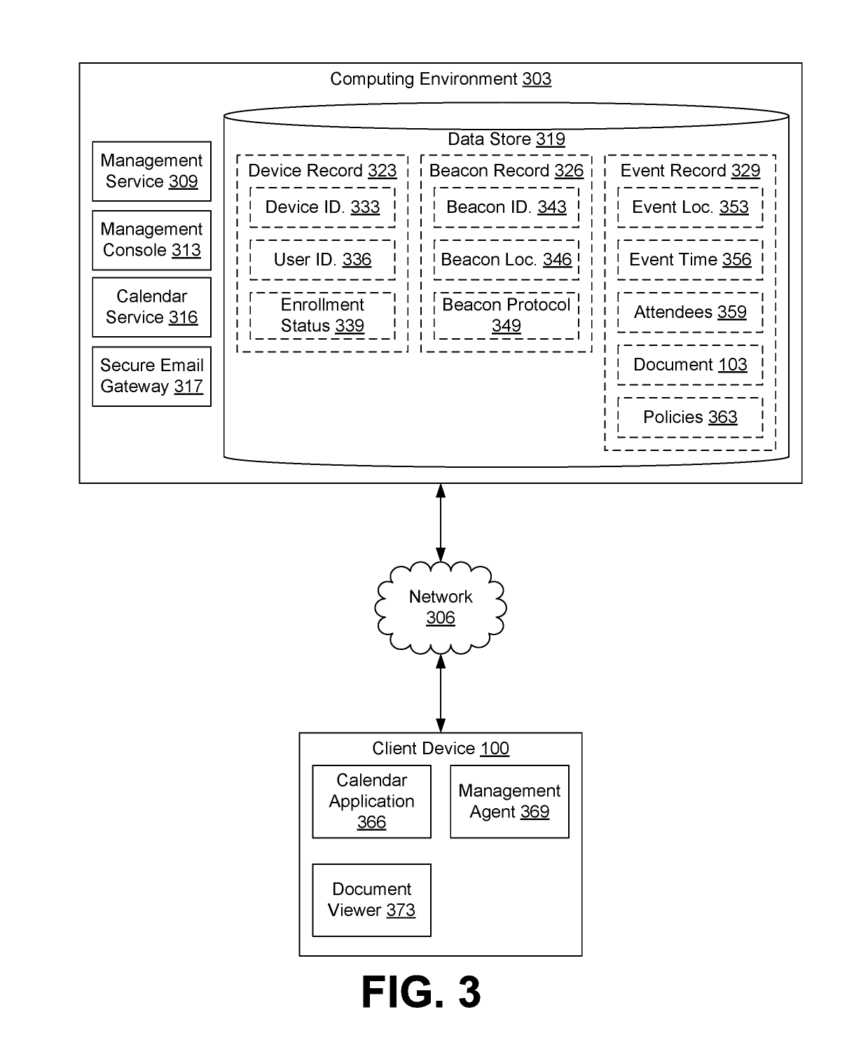

FIG. 3 is a schematic block diagram depicting a networked environment 300 according to various embodiments of the present disclosure. The networked environment 300 includes a computing environment 303 and a client device 100, which are in data communication with each other over a network 306. The network 306 can include the Internet, intranets, extranets, wide area networks (WANs), local area networks (LANs), wired networks, wireless networks, or other suitable networks, as well as any combination of two or more networks. For example, the network 306 can include a satellite network, a cable network, an Ethernet network, and other types of networks.

The computing environment 303 can include a server computer or any other system providing computing capability. Alternatively, the computing environment 303 can employ a plurality of computing devices that can be arranged in one or more server banks, computer banks, or other arrangements. The computing devices can be located in a single installation or can be distributed among many different geographical locations. For example, computing environment 303 can include a plurality of computing devices that together include a hosted computing resource, a grid computing resource, or any other distributed computing arrangement. In some cases, the computing environment 303 can correspond to an elastic computing resource where the allotted capacity of processing, network, storage, or other computing-related resources that vary over time.

Various applications or other functionality can be executed in the computing environment 303 according to various embodiments. The components executed on the computing environment 303 can include a management service 309, a management console 313, a calendar service 316, and a secure email gateway 317. However, other applications, services, processes, systems, engines, or functionality can be provided by the enterprise computing environment 103.

The management service 309 can administer the operation of client devices 100 registered or otherwise enrolled with the management service 309. To this end, the management service 309 can enforce or otherwise require particular applications to be installed on an enrolled client device 100, require the client device 100 to be configured in a particular manner, or require that particular features be enabled or disabled on the client device 100, as further described below. Similarly, the management service 309 can configure the operation of individual applications executing on the client device 100, such as limiting access of an application to particular files, network resources, or resources on the client device 100, as further described below.

The management service 309 can also provide for facilities for a client device 100 to enroll with the management service 309. The facilities can include a web page containing one or more information fields that are completed and submitted by a user. The facilities can also include a registration API used by management software installed on the client device 100.

The management console 313 can provide an administrative interface for configuring the operation of the management service 309 and the configuration of client devices 100 that are administered by the management service 309. Accordingly, the management console 313 can correspond to a web page or web application provided by a web server hosted in the computing environment 303.

The calendar service 316 can provide an electronic version of a calendar to client devices 100 accessing the calendar service 316 across the network 306. The calendar service 316 can provide various features or functions, including managing a list of events (e.g., appointments, due dates, or meetings), managing an address book, managing a contact list, and similar functions. In order to perform these calendar management features, the calendar service 316 can create events, modify events, delete events, show a user's availability to other users, invite other users to add an event to their respective calendars, check the availability of other users, as well as perform other, related functions. Examples of a calendar service 316 include MICROSOFT EXCHANGE®, GOOGLE CALENDAR®, IBM DOMINO®, and YAHOO! CALENDAR®.

The secure gateway 317 can be configured to act as a proxy server for connections from client devices 100 to the calendar service 316. Accordingly, any communications or messages between the client device 100 and the calendar service 316 can be accessed, examined, or modified by the secure gateway 317. The secure gateway 317 can be used in order to examine communications, such as event invitations, event notifications, or other messages for security purposes. For example, the secure gateway 317 could examine an event invitation to determine whether one or more documents 103 attached included a virus, trojan, or other malware. As another example, the secure gateway 317 could examine event invitations to determine whether they comply with various policies and take an appropriate action based on the determination. In other examples, the secure gateway 317 could analyze an event invitation or creation request and create an event record 329 or modify an event record 329 created by the calendar service 316. This approach would allow for functionality not included in the calendar service 316 to be provided to the client device 100 or calendar application 366. For example, the secure gateway 317 could be used to extend the functionality of a third-party calendar service 316, such as MICROSOFT EXCHANGE. Accordingly, any functions described herein as being provided by the calendar service 316 could similarly be provided by the secure gateway 317 in order to extend the functionality of a third-party calendar service 316.

Various data is stored in a data store 319 that is accessible to the computing environment 303. The data store 319 can include one or more relational databases or non-relational databases (e.g., hierarchical databases, key-value databases, object databases, files, or other non-relational databases). The data stored in the data store 319 is associated with the operation of the various applications or functional entities discussed in this application. The data can include device records 323, beacon records 326, and event records 329

A device record 323 can represent information related to a client device 100. For example, a device record 323 can include a device identifier 333, a user identifier, and an enrollment status 339. In some examples, other information can also be stored in the device record 323 as needed.

A device identifier 333 can represent data that uniquely identifies a client device 100 with respect to another client device 100. The device identifier 333 can include a serial number, digital signature, advertising identifier, universally unique identifier (UUID), a globally unique identifier (GUID), a media access control (MAC) address, or similar identifier. The device identifier 333 can be stored on the client device 100 and provided to the management service 309 when the client device 100 enrolls or registers with the management service 309, or the device identifier 33 can be generated by the management service 309 and assigned to the client device 100 when the client device 100 enrolls or registers with the management service 309.

A user identifier 336 can represent data that uniquely identifies a user of the client device 100 with respect to other users or potential users. For example, the user identifier 336 can include a user name, an email address, a user identification number, or similar unique identifier. The user identifier 336 can, in some instances, be assigned to a user by the management service 309 when the client device 100 enrolls with the management service 309.

An enrollment status 339 represents whether a client device 100 is currently registered or enrolled with the management service 309. In some instances, the enrollment status 339 can be set to a default value of unregistered or unenrolled. The default status can then be changed by the management service 309 to a value of registered or enrolled when a client device 100 enrolls with the management service 309. Likewise, if a client device 100 unenrolls from the management service 309, the management service 309 can revert or change back the enrollment status 339 to reflect the unregistered or unenrolled state.

A beacon record 326 can include data representing or otherwise associated with a beacon 200. For example, a beacon record 326 can include a beacon identifier 343, a beacon location 346, and a beacon protocol 349. In some instances, additional data can be included in a beacon record 326 as required for a specific scenario or implementation.

A beacon identifier 343 represents a unique identifier that uniquely identifies a beacon 200 with respect to other beacons 200. For example, the beacon identifier 200 can include a hardware identifier, such as a MAC address of the broadcast radio of the beacon 200. In other instances, the beacon identifier 200 can include unique identifiers such as a UUID or GUID assigned to the beacon 200.

A beacon location 346 can represent the physical or geographical location of a beacon 200. This information can be represented in a variety of formats. For example, it can be represented as a room name or number (e.g., the “15^{th} Floor Large Conference Room” or “Room 1885”), a building name (e.g. the Burdell Building), an address (e.g. 500 North Ave., Atlanta, Ga. 30332), or a combination of latitude and longitude coordinates (e.g. 75° W, 38° N).

A beacon protocol 349 can represent the protocol the beacon 200 can use to communicate with client devices 100. Examples of beacon protocols 349 include the APPLE IBEACON and GOOGLE EDDYSTONE protocols. In some instances, the beacon protocol 349 can also indicate the version of the protocol being used by the beacon 200.

An event record 329 can represent information corresponding to various types of events. For example, an event record 329 can represent a meeting, an appointment, a due date, or other event. For any event, a corresponding event record 329 can include information such as an event location 353, an event time 356, attendees 359 of the event, one or more documents 103 linked to the event, various applicable policies 363, and other information related to the event.

An event location 353 identifies where the event will occur. This information can be stored in a variety of formats. For example, it can be represented as a room name or number (e.g., the “15^{th} Floor Large Conference Room” or “Room 1885”), a building name (e.g. the Burdell Building), an address (e.g. 500 North Ave., Atlanta, Ga. 30332), or a combination of latitude and longitude coordinates (e.g. 75° W, 38° N).

An event time 356 can indicate when the event will start and when the event will end. This can include the date or dates for which the event is scheduled and the time of day for the event.

Attendees 359 of the event include identifiers of each individual that is expected to attend the event. In some instances the attendees 359 can correspond to a list of user identifiers 336. In other instances, the attendees 359 can correspond to a list of device identifiers 333 of the client devices 100 of the individuals expected to attend. In some examples, the attendees 359 can include both the device identifiers 333 and the user identifiers 336 of those individuals expected to attend.

A document 103 represents a document 103 associated with the meeting. For example, a meeting might have an agenda to be distributed to attendees, reports to be distributed to attendees, or other documents to be viewed by or made available to attendees. In some instances, a copy of the document 103 can be stored within the event record 329 itself. In other instances, the event record 329 can store a link or reference to the document that identifies the location where the document 103 is currently stored.

Policies 363 represent various policies applicable to the event record 329. These policies 363 can be used to limit or control access to documents 103 based on various criteria or constraints. For example, a policy 363 can specify that a document 103 is only available to individual attendees 359. As another example, a policy 363 can specify that a document 103 is only available to an attendee 359 as long as the client device 100 of the attendee is at the event location 353. In some examples, a policy 363 can specify that a document 103 is only available to an attendee 359 for the duration of the event.

In some instances, multiple policies 363 can also be assigned to an event record 329. In these instances, all policies 363 would have to be satisfied in order for an attendee 359 to access a document 103. For example, if a first policy 363 specified that documents 103 can only be viewed while an attendee 359 is at the event location 353 and a second policy 363 specified that an attendee 359 can only view documents 103 for the duration of the event, then an attendee 359 can only view documents 103 while the event is in progress and while they are at the event.

The client device 100 is representative of one or more client devices 100 that can be coupled to the network 306. The client device 100 can include a processor-based system, such as a computer system. The computer system can include a desktop computer, a laptop computer, a personal digital assistant, a cellular telephone, a smartphone, a set-top box, a music player, a web pad, a tablet computer system, a game console, an electronic book reader, a wearable computing device, an augmented reality or virtual reality device, or another device with like capability.

The client device 100 can be configured to execute various applications. For example, the client device 100 can be configured to execute a calendar application 366, a management agent 369, and a document viewer 373. In some instances, the client device 100 can be configured to execute additional applications as needed.

The calendar application 366 can communicate across the network 306 with the calendar service 316 to provide calendar functions on the client device 100. For example, the calendar application 366 can communicate with the calendar service 316 to retrieve event information, event invitations, and similar information for presentation on the client device 100 to a user. As another example, the calendar application 366 can provide an interface to a user for creating and modifying events and then sending the newly created or modified events to the calendar service 316. Examples of calendar applications 366 include MICROSOFT OUTLOOK®, IBM NOTES®, MOZILLA THUNDERBIRD®, APPLE CALENDAR®, GNOME EVOLUTION, and similar applications. However, in some instances, the calendar application 366 can correspond to a web-page front end of a calendar service 316 rendered in a web browser. Examples of these instances include GOOGLE CALENDAR®, MICROSOFT OUTLOOK WEB ACCESS®, YAHOO CALENDAR®, MICROSOFT LIVE CALENDAR®, and similar applications.

The management agent 369 can be configured to communicate with the management service 309 in order to facilitate management of the client device 100. For example, the management agent 369 can be configured to communicate with the management service 309 to enroll or register the client device 100 with the management service 309. Enrollment or registration can be configured to occur automatically after the management agent 369 is installed on the client device 100 or in response to a user requesting enrollment or registration of the client device 100. As another example, the management agent 369 can perform various management functions on the client device 100 in response to instructions received from the management service 309. For instance, the management agent 369 can be configured to require an application be installed on a client device 100, such as the document viewer 373. In other instances, the management agent 369 can cause values to be specified for particular application settings and override user changes to those settings. Other management functionality can additionally be incorporated into the management agent 369 in various examples.

However, the management agent 369 may be omitted in some examples. In these examples, the functions provided by the management agent 369 can instead be incorporated into the management service 309. For example, the management service 309 can be configured to send instructions to operating system of the client device 100 or the document viewer 373 directly. For instance, the management service 309 could send an instruction to the operating system of the client device 100 to install the document viewer 373 or other applications. Likewise, the management service 309 could send instructions to the document viewer 373 to configure a setting in a particular manner.

The document viewer 373 can provide access to documents 103 in accordance with applicable policies 363. In some instances, the document viewer 373 can be configured to download and display one or more documents 103 when the client device 100 is in compliance with all applicable policies 363. For example, a policy 363 can specify that a document 103 can only be accessed when the client device 100 is at the event location 353. The document viewer 373 can determine whether the client device 100 is receiving a signal from a beacon 200. The document viewer 373 can then compare the beacon identifier 343 of the beacon 200 to the beacon identifier 343 specified in a beacon record 326 containing a beacon location 346 that matches the event location 353. If the client device 100 is receiving a signal from the correct beacon 200, the document viewer 373 would then download and display the documents 103 listed in the event record 329. If the client device 100 ceased to receive the signal from the correct beacon 200, then the document viewer 373 would delete the documents 103 from the client device 100 and stop displaying them to the user.

As another example, if a policy 363 specifies that a document 103 can only be accessed for the duration of the event, then the document viewer 373 can compare the current time with the event time 356 in order to see if the event is still in progress. If the event is still in progress, the document viewer would then download and display the documents 103 listed in the event record 329. Once the event finishes, the document viewer 373 would delete the documents 103 from the client device 100 and stop displaying them to the user.

Next, a general description of the operation of the various components of the networked environment 300 is provided. The various components of the networked environment 300 can be configured to operate in several ways. Several of the potential configurations are detailed in the following discussion.

To begin, an event record 329 is created for an event, such as a meeting. The event record 329 can be created, for example, using the calendar application 366. The calendar application 366 then communicates the details of the event to the calendar service 316, which creates a new event record 329 based on the details provided by the calendar application 366. The calendar service 316 can, in some instances, perform some data validity checks prior to creating the event record 329. Similarly, the secure gateway 317 could create a new event record 329 based on the details provided by the calendar application 366 and perform some data validity checks prior to creating the event record 329.

For example, if a policy 363 specifies that attendees 359 can only access documents 103 while the attendees 359 are at the event location 353, the calendar service 316 can determine if a beacon record 326 containing a beacon location 346 that matches the event location 353 exists. If the necessary beacon record 326 does not exist, then the calendar service 316 can send an error message to the calendar application 366. The calendar service 316 can then decline to create the event record 329 until a valid combination of event settings is provided by the calendar application 366.

As part of the creation process 329, the calendar service 316 or secure gateway 317 can create a policy 363 based on information included in the request to create an event. For example, if a request to create an event included a list of attendees 359 and an event location 353, the calendar service 316 or the secure gateway 317 could create a policy 363 limiting access to documents 103 linked to the event record 329 to the event time 356 while an attendee is in proximity to the event location 353.

Once the event record 329 is created, the calendar service 316 can send an invitation to the meeting to the client device 100 of each attendee 359 listed in the event record 329. The invitation can include details about the meeting, such as the event location 353, the event time 356, the attendees 359, and any documents 103 associated with the event. In some instances, the invitation can include a link to the documents 103 instead of the documents themselves.

The calendar service 316 can, in some instances, be configured to send different versions of the invitation to different attendees 359. For example, the calendar service can send attendees 359 who have client devices 100 enrolled with the management service 309 an invitation containing a link to the documents 103 that allows the document viewer 373 to retrieve and display the documents 103 at the appropriate place and time. However, the calendar service can send attendees 359 who have client devices 100 that are not enrolled or registered with the management service 309 a link to the management service 309. The link to the management service 309 can provide a mechanism through which a user can enroll or register his or her client device 100 with the management service 309. For example, the link can allow a client device 100 to download a copy of the management agent 369, which would register or enroll the client device 100 after installation. As another example, the link can lead to a web page that allows a user to complete and submit a form that acts as registration or enrollment of his or her client device 100. Once enrolled, the management agent 369 can cause the document viewer 373 to be downloaded to and installed on the client device 100.

The calendar service 316 can be configured to communicate with the management service 309 to determine which attendees 359 receive which version of the meeting invitation. For example, the calendar service 316 can provide the list of attendees 359 to the management service 309 to determine which attendees 359 have client devices 100 registered or enrolled with the management service 309. The management service 309 can then check the enrollment status 339 of each device record 323 with a user identifier 336 matching a user identifier 336 included in the attendees 359. Based on the enrollment status 339, the management service 309 can provide the calendar service 316 with the identities of attendees 359 that are currently enrolled with the management service 309.

Subsequently, the calendar application 366 receives the meeting invitation from the calendar service 316. In response, the calendar application 366 can display information related to the meeting to the user and prompt the user to accept or decline the meeting. For example, the calendar application 366 can show one or more of the event location 353, event time 356, attendees 359, and the link inserted by the calendar service 316. The calendar application 366 can also prompt the user to accept or decline the meeting invitation, indicating whether or not the user will attend.

When the meeting begins, the document viewer 373 can determine whether or not the user is authorized to view any of the documents 103 related to the meeting. For example, the document viewer 373 can query the management agent 369, which can in turn query the management service 309, for a list of applicable policies 363. However, in some instances, the document viewer 373 can query the management service 309 directly to retrieve the applicable policies 363. After receiving the policies 363, the document viewer 373 can evaluate the policies 363 and determine whether or not the user or client device 100 is currently in compliance with each of the policies 363. If the user or client device 100 complies with all of the applicable policies, then the document viewer 373 displays the documents 103 on the client device 100.

The document viewer 373 can also poll the status of the client device 100 periodically to confirm continued compliance with each of the policies 363. If the client device 100 ceases to be in compliance with at least one policy 363, then the document viewer 373 can cease to display the documents 103 on the client device 100. For example, if a policy 363 specifies that the client device 100 must be near the event location 353 if any of the documents 103 are to be displayed, then the document viewer 373 can periodically (e.g., every second, every 5 seconds, every 30 seconds, every minute, or some other interval) check whether the client device 100 is receiving a beacon identifier 343 broadcast by a beacon 200 corresponding to a beacon location 346 that matches the event location 353. If the client device 100 is no longer receiving the beacon identifier 343, then the document viewer 373 can stop displaying the documents 103 until the client device 100 begins to receive the beacon identifier 343 again.

After the meeting ends, the document viewer 373 can cease displaying the documents 103 to the user of the client device 100. In some instances, this can be a preprogrammed behavior of the document viewer 373. In other instances, this can be accomplished through the user of a policy 363 specifying that access to a document 103 is limited to the duration of the meeting.

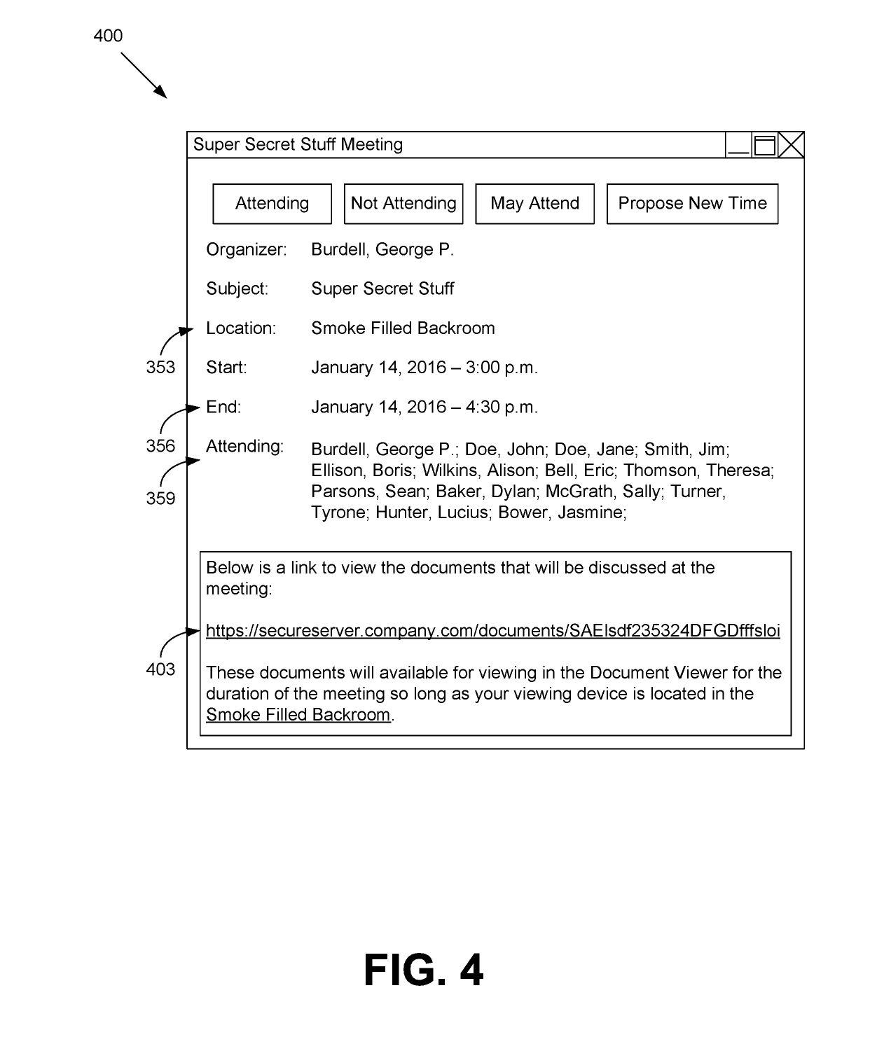

FIG. 4 depicts an example of an invitation 400 to an event in various instances. The invitation 400 can be rendered by the calendar application 366 in response to the creation of an event record 329. For example, if one user scheduled a meeting through the calendar service 316, the invitation 400 depicted in FIG. 4 can be presented to one of the attendees 359.

As depicted in FIG. 4, the invitation can include information stored as part of the event record 329. This can include the event location 353 and the event time 356. In some instances, the invitation can also include a listing of attendees 359. The invitation can also include a link 403 that provides access to one or more documents 103 associated with the meeting.

In some invitations 400, the link 403 provides a location, such as a uniform resource locator (URL) which the document viewer 373 can use to retrieve documents 103 associated with the event record 329 for the event. The link 403 can potentially include authentication information, such as a one-time passcode that limits the link 403 to a single use. This can prevent multiple users from using the same link 403 to access the documents 103. Similarly, the link 403 to the documents 103 can be unique for each attendee, which can allow the calendar service 316 or the management service 309 to track which users have attempted to access the documents 103 using the document viewer 373.

In other invitations 400, the link 403 can direct a client device 100 to register or enroll with the management service 309. This can occur, for example, when an invitation 400 is sent to a user or a client device 100 which is not yet registered or enrolled with the management service 309. Once the client device 100 enrolls or registers with the management service 309, the management service 309 can notify the calendar service 316 of the enrollment, and the calendar service 316 can send an updated invitation 400 containing a link 403 to the documents 103.

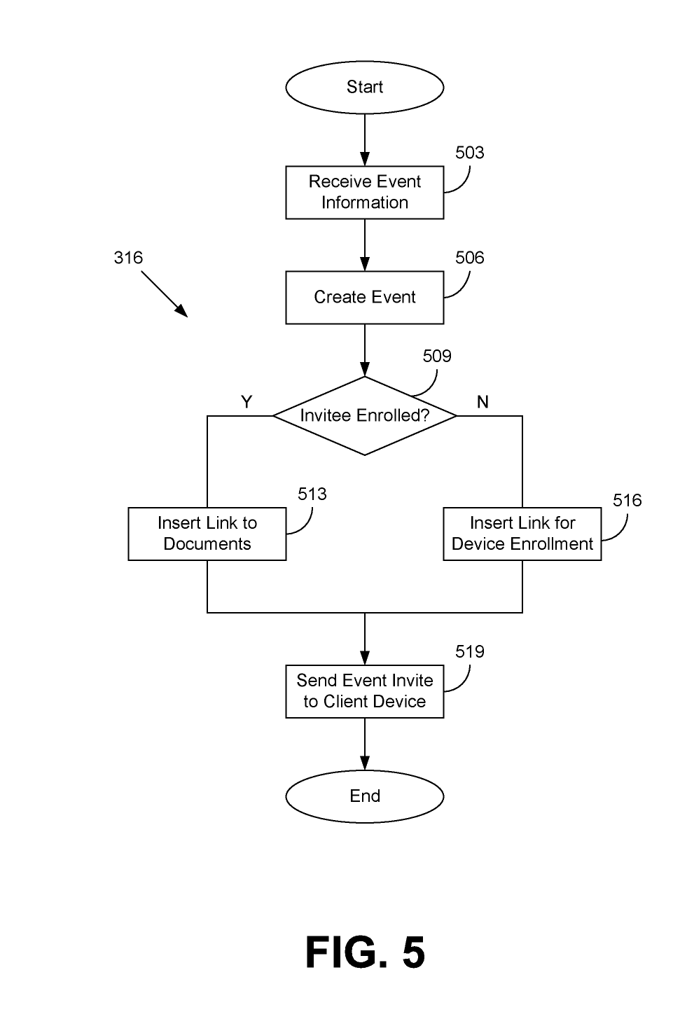

Referring next to FIG. 5, shown is a flowchart depicting the operations of various portions of the calendar service 316. The calendar service 316 can perform one or more steps depicted in the flowchart of FIG. 5 to generate an invitation 400 to send to an individual invited to attend an event. In instances where multiple individuals are invited, one or more of the steps described in the flowchart of FIG. 5 can be performed for each individual.

Beginning with step 503, the calendar service 316 receives event information from a calendar application 366 executing on a client device 100. For example, a user may have created a meeting using a calendar application 366. Accordingly, the calendar application 366 can send a request to the calendar service 316 to create an event record 329 for the meeting. The request from the calendar application 366 can include an event location 353, an event time 356, a list of attendees 359, an identification of one or more documents 103 associated with the event, and an identification of one or more policies 363 governing access to the documents 103 linked to the event.

Moving on to step 506, the calendar service 316 creates an event record 329 corresponding to an event. The calendar application 366 can save the provided event location 353, event time 356, list of attendees 359, identification of documents 103 associated with the event, and specified policies 363 as part of the event record 329.

Proceeding to step 509, the calendar service 316 determines whether an invitee to the event is currently enrolled with the management service 309. Enrollment or registration can indicate that the client device 100 of the user has a management agent 369 and document viewer 373 installed on the client device 100, which would ensure that the client device 100 is able to view the documents 103 in a manner that complies with one or more policies 363. If an attendee's client device 100 is not enrolled or registered, then the management service 309 would be unable to control access to the documents 103 in a manner that complies with the policies 363 governing the event.

To determine whether a client device 100 is enrolled or registered with the management service 309, the calendar service 316 can send a user identifier 336 included in the list of attendees 359 to the management service 309. The management service 309 can then search for a device record 323 corresponding to the user identifier 336 and provide the corresponding enrollment status 339 to the calendar service 316. If the enrollment status 339 reflects that a client device 100 associated with the user is enrolled or registered with the management service 309, then the process proceeds to step 513. However, if the enrollment status 339 reflects that no client devices 100 associated with the user are currently enrolled or registered with the management service 309, then the process proceeds to step 516.

Referring next to step 513, the calendar service 316 inserts a link 403 into an invitation 400 that can provide a document viewer 373 access to the documents 103 associated with the event record 329. The link 403 can correspond to a URL reflecting a network location where the documents can be accessed. The URL can, in some instances, include a one-time use token or code that allows that documents 103 to be accessed only once with the link 403 in order to prevent a client device 100 from access the documents 103 multiple times or to prevent additional, potentially unauthorized users from accessing the documents 103. Similarly, the link 403 can include a unique code or token for each attendee 359, thereby making each link 403 for each attendee 359 unique.

However, if the process proceeds to step 516, the calendar service 316 can insert a link 403 into an invitation 400 that, when followed, allows a user to register or enroll his or her client device 100. This link 403, for example, can direct a user to download and install a copy of the management agent 369. When the management agent 369 is installed on the client device 100, the management agent 369 can automatically register or enroll the client device 100 with the management service 309. After registration is completed, the management agent 369 can then cause the document viewer 373 to be downloaded and installed on the client device 100 in order for documents 103 associated with the event record 329 to be viewed on the client device 100.

Moving on to step 519, the calendar service 519 sends the invitation 400 to the user. The invitation 400 can be sent in an email, in a text message, or as a notification or update sent to the calendar application 366. As a result, the user is invited to attend a meeting.

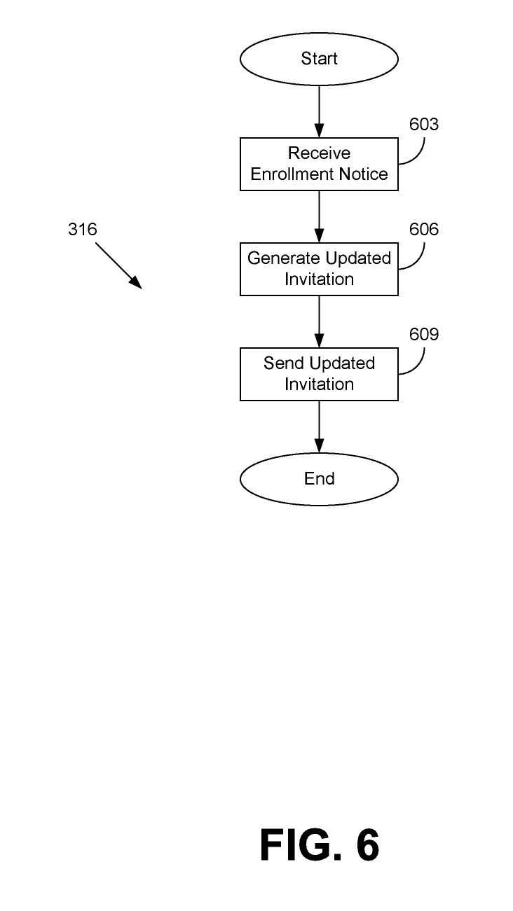

Referring next to FIG. 6, shown is a flowchart depicting the operations of various portions of the calendar service 316. The calendar service 316 can perform one or more steps depicted in the flowchart of FIG. 5 to update an invitation 400 after a client device 100 has enrolled with the management service 309.

Beginning with step 603, the calendar service 316 receives a notification from the management service 309 that the enrollment status 339 of a client device 100 has changed to reflect a registered or enrolled state. In some instances, the notification can be sent by the management service 309 in response to registration of an unregistered client device 100. In other instances, the calendar service 316 can periodically (e.g., every minute, 5 minutes, 10 minutes, or other interval) query the management service 309 to determine if the enrollment status 339 of a client device 100 associated with an attendee 359 has changed. In response to one of the queries submitted by the calendar service 316, the management service 309 can provided an updated version of the enrollment status 339 to the calendar service 316.

Moving on to step 606, the calendar service 316 can generate a new or updated invitation 400 to the event corresponding to the event record 329. The new or updated invitation 400 can include the same event location 353, event time 356, and attendees 359 as the previous version of the invitation 400. However, a new link 403 can be inserted in to the invitation that provides a URL for a document viewer 373 to access the documents 103 associated with the event record 329.

Proceeding to step 609, the calendar service 316 sends the new or updated invitation 400 to the user. The new or update invitation 400 can be sent in an email, a short message service (SMS) message, or as a notification or update sent to the calendar application 366. As a result, the user is provided with an updated invitation 400 to the event that includes a link 403 to the documents 103 included in the event record 329 corresponding to the event.

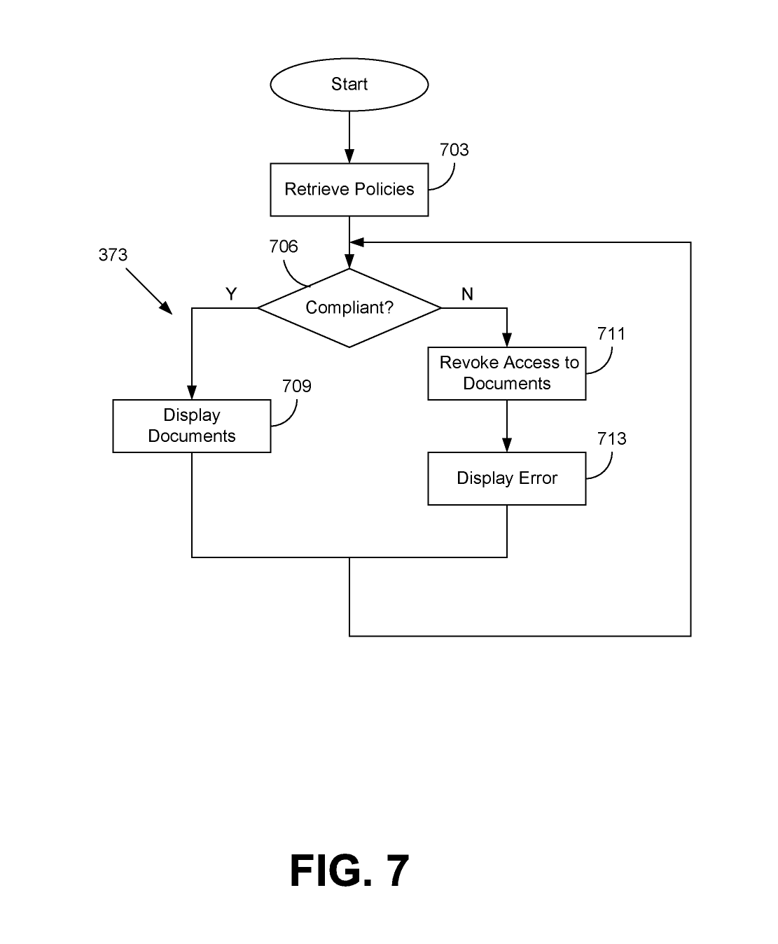

Referring next to FIG. 7, the operation of various portions of the document viewer 373 are depicted. The process depicted in FIG. 7 can be performed by the document viewer 373 in order to limit access to documents 103 based on one or more policies 363. For example, the process depicted in FIG. 7 can be performed by the document viewer 373 in order to limit access to documents 103 to the duration of a meeting at the meeting location.

Beginning with step 703, the document viewer 373 retrieves one or more policies 363 included in an event record 329. For example, in some implementations, the document viewer 373 can issue a request to the calendar service 316 for the policies 363 included in the event record. However, in other implementations the management service 309 can also have access to individual event records 329. In these implementations, the document viewer 373 can alternatively send a request to the management service 309 for the policies 363 included in an individual event record 329. In either implementation, the document viewer 373 can receive any policies 363 assigned to the event record 329 in response to the request.

Proceeding to step 706, the document viewer 373 determines whether the client device 100 is compliant with each policy 363. In some configurations, a client device 100 can be required to comply with each policy 363 in order for the document viewer 373 to display the documents 103. In other configurations, the document viewer 373 can be configured to display the documents 103 as long as the client device 100 complies with at least one policy.

For example, a policy 363 can specify that a document 103 can only be viewed on the client device 100 when the client device 100 is in proximity to the event location 353. To determine whether the client device 100 complies with the policy 363, the document viewer 373 can request the identification of a beacon identifier 343 of a beacon 200 with a beacon location 346 that matches the event location 353. The client device 100 can then store this beacon identifier 343 and check to see if the client device 100 is currently receiving a broadcast from a beacon 200 containing the beacon identifier 343. If the client device 100 is receiving a broadcast containing the beacon identifier 343, then the document viewer 373 can conclude that the client device 100 is in compliance with the policy 363. The process can then continue to step 709. However, if the client device 100 is not receiving a broadcast containing the beacon identifier 343, then the document viewer 373 can conclude that the client device 100 is not in compliance with the policy 363. The process can then continue instead to step 713.

As another example, a policy 363 can specify that a document 103 can only be viewed on the client device 100 while the event is in progress. Accordingly, the document viewer 373 can request the event time 356 from the calendar service 316. The document viewer 373 can then compare the event time 356 with the current time. To prevent circumvention of the policy 363, the document viewer 373 can request the current time from a network time protocol (NTP) server instead of using a clock on the client device 100. If the current time falls within the duration of the event, as derived from the event time 356, then the document viewer 373 can conclude that the client device 100 is in compliance with the policy 363. The process can then continue to step 709. However, if the current time falls outside the duration of the event, as derived from the event time 356, then the document viewer 373 can conclude that the client device 100 is not in compliance with the policy 363. The process can then continue to step 711.

Referring next to step 709, the document viewer 373 makes the documents 103 available to the user for display. In some instances, the document viewer 373 can download the documents 103 at this time.

However, if the process instead proceeds to 711, the document viewer 373 can revoke access to the documents 103. As part of the revocation process, the document viewer 373 could modify access permissions to the documents 103 to make the documents 103 unreadable to the user. In some instances, the document viewer 373 could delete or otherwise remove documents 103 from the client device 100. Alternatively, the document viewer 373 could encrypt the documents 103 with a key unknown to the user (e.g. an encryption key provided by the management service 309) in order to prevent the user from accessing the documents 103.

Moving on to step 713, the document viewer 373 can display an error message on the display of the client device 100. The error message can include, for example, an identification of the policy 363 that was violated (e.g., not within range of beacon 200 or meeting is not currently in progress) and which documents had access revoked.

The process then proceeds back to step 706 and is repeated again. By repeating steps 706, 709, 711, and 713, the document viewer 373 can continuously evaluate whether the client device 100 continues to comply with the policies 363. This allows the document viewer 373 to prevent a user from trying to access documents 103 outside of the event. For example, by repeatedly evaluating compliance with a policy 363 governing the location of the client device 100, the document viewer 373 can provide access to documents 103 while a client device 100 is in proximity to the event location 353. However, access to the documents 103 can then be revoked when the client device 100 leaves the event location 353. For example, if a user attempts to take a client device 100 away from a meeting in order to make copies unnoticed (e.g., photographing the screen of the client device 100), the document viewer 373 would no longer provide access to the documents 103. Likewise, once a meeting is over, the document viewer 373 would no longer provide access to the documents 103.

As a result of the process depicted in FIG. 7, the document viewer 373 can limit access to documents 103 based on the location of the client device or the current time. This allows for client devices 100 to be used to view documents 103 that are only intended for limited distribution or access.

Although the flowcharts of FIGS. 5-7 show a specific order of execution, it is understood that the order of execution can differ from that which is shown. The order of execution of two or more elements can be switched relative to the order shown. Also, two or more elements shown in succession can be executed concurrently or with partial concurrence. Further, in some examples, one or more of the elements shown in the flowcharts can be skipped or omitted. In addition, any number of counters, state variables, warning semaphores, or messages can be added to the logical flow described herein, for purposes of enhanced utility, accounting, performance measurement, or troubleshooting aid. It is understood that all of these variations are within the scope of the present disclosure.

The individual components of the computing environment 303 and the client device 100, or other components described herein, can each include at least one processing circuit. The processing circuit can include one or more processors and one or more storage devices that are coupled to a local interface. The local interface can include a data bus with an accompanying address/control bus or any other suitable bus structure. The one or more storage devices for a processing circuit can store data or components that are executable by the one or processors of the processing circuit. Also, a data store can be stored in the one or more storage devices.

The management service 309, management console 313, calendar service 316, calendar application 366, management agent 369, document viewer 373, and other components described herein, can be embodied in the form of hardware, as software components that are executable by hardware, or as a combination of software and hardware. If embodied as hardware, the components described herein can be implemented as a circuit or state machine that employs any suitable hardware technology. The hardware technology can include one or more microprocessors, discrete logic circuits having logic gates for implementing various logic functions upon an application of one or more data signals, application specific integrated circuits (ASICs) having appropriate logic gates, programmable logic devices (for example, field-programmable gate array (FPGAs), and complex programmable logic devices (CPLDs)).

Also, one or more or more of the components described herein that include software or program instructions can be embodied in any non-transitory computer-readable medium for use by or in connection with an instruction execution system such as a processor in a computer system or other system. The computer-readable medium can contain, store, or maintain the software or program instructions for use by or in connection with the instruction execution system.

The computer-readable medium can include physical media, such as, magnetic, optical, semiconductor, or other suitable media. Examples of a suitable computer-readable media include, but are not limited to, solid-state drives, magnetic drives, flash memory. Further, any logic or component described herein can be implemented and structured in a variety of ways. One or more components described can be implemented as modules or components of a single application. Further, one or more components described herein can be executed in one computing device or by using multiple computing devices.

The above-described examples of the present disclosure are merely examples of implementations to set forth for a clear understanding of the principles of the disclosure. Many variations and modifications can be made to the above-described examples without departing substantially from the spirit and principles of the disclosure. All of these modifications and variations are intended to be included herein within the scope of this disclosure.

Therefore, the following is claimed:

1. A system, comprising:
a computing device comprising a processor and a memory; and
an application comprising machine readable instructions stored in the memory, wherein the machine readable instructions, when executed by the processor, cause the computing device to at least:
create an event comprising a start time of the event and an end time of the event;
assign a beacon identifier to the event;
link a document to the event; and
send an invitation to a client device, wherein the invitation corresponds to the event.

2. The system of claim 1, wherein the application further comprises machine readable instructions that, when executed by the processor, cause the computing device to further:
determine that the client device is unenrolled with respect to a management service; and
insert a link into the invitation, wherein the link is configured to initiate enrollment of the client device with the management service.

3. The system of claim 2, wherein the application further comprises machine readable instructions that, when executed by the processor, cause the computing device to further:
receive a notification from a management service that the client device has enrolled with the management service;
generate an updated invitation comprising a link configured to provide access to the document; and
send the updated invitation to the client device.

4. The system of claim 1, wherein the application further comprises machine readable instructions that, when executed by the processor, cause the computing device to further:
determine that the client device is enrolled with respect to a management service; and
insert a link to the document into the invitation.

5. The system of claim 4, wherein the link provides access to the document when the client device is within range of a beacon corresponding to the beacon identifier.

6. The system of claim 4, wherein the link provides access to the document between the start time of the event and the end time of the event.

7. The system of claim 1, wherein application further comprises machine readable instructions that, when executed by the processor, cause the computing device to further:
evaluate a policy associated with the event for compliance by the client device; and
send a command to the client device to revoke access to the document in response to a determination that the client device fails to comply with the policy.

8. A method, comprising:
creating an event comprising a time and a duration;
assigning a beacon identifier to the event;
linking a document to the event; and
sending an invitation to a client device, wherein the invitation corresponds to the event.

9. The method of claim 8, further comprising:
determining that the client device is unenrolled with respect to a management service; and
inserting a link into the invitation, wherein the link is configured to initiate enrollment of the client device with the management service.

10. The method of claim 9, further comprising:
receiving a notification from a management service that the client device has enrolled with the management service;
generating an updated invitation comprising a link configured to provide access to the document; and
sending the updated invitation to the client device.

11. The method of claim 8, further comprising:
determining that the client device is enrolled with respect to a management service; and
inserting a link to the document into the invitation.

12. The method of claim 11, wherein the link provides access to the document when the client device is within range of a beacon corresponding to the beacon identifier.

13. The method of claim 11, wherein the link provides access to the document for the duration of the event.

14. The method of claim 8, further comprising:
evaluating a policy associated with the event for compliance by the client device; and
sending a command to the client device to revoke access to the document in response to a determination that the client device fails to comply with the policy.

15. A non-transitory computer readable medium comprising machine readable instructions that, when executed by a processor of a computing device, cause the computing device to at least:
create an event comprising a time and a duration;
assign a beacon identifier to the event;
link a document to the event; and
send an invitation to a client device, wherein the invitation corresponds to the event.

16. The non-transitory computer readable medium of claim 15, wherein the machine readable instructions further cause the computing device to at least:
determine that the client device is unenrolled with respect to a management service; and
insert a link into the invitation, wherein the link is configured to initiate enrollment of the client device with the management service.

17. The non-transitory computer readable medium of claim 15, wherein the machine readable instructions further cause the computing device to at least:
determine that the client device is enrolled with respect to a management service; and
insert a link to the document into the invitation.

18. The non-transitory computer readable medium of claim 15, wherein the link provides access to the document when the client device is within range of a beacon corresponding to the beacon identifier.

19. The non-transitory computer readable medium of claim 15, wherein the link provides access to the document for the duration of the event.

20. The non-transitory computer readable medium of claim 15, wherein the beacon identifier corresponds to a universally unique identifier (UUID) formatted in compliance with a version of the iBeacon® protocol.
